(19) United States
(12) Patent Application Publication
(10) Pub. No.: US 2024/0177050 A1
(43) Pub. Date: May 30, 2024

(54) NEURAL NETWORK-BASED LOAD BALANCING IN DISTRIBUTED STORAGE SYSTEMS

(71) Applicant: Red Hat, Inc., Raleigh, NC (US)

(72) Inventors: Harika Chebrolu, Hyderabad (IN); Sunil Angadi, Karnataka (IN)

(21) Appl. No.: 18/059,218

(22) Filed: Nov. 28, 2022

(51) Int. Cl. G06N 20/00; G06F 9/50

(52) U.S. Cl. CPC G06N 20/00; G06F 9/5027

(57) ABSTRACT

A system, method, and computer readable medium train machine learning model using server parameters corresponding to a plurality of servers. The training produces an optimized feature set of the machine learning model. The system, method, and computer readable medium assign a server class to a received request based on the optimized feature set. The system, method, and computer readable medium compute, based on the optimized feature set, estimate response times for one or more servers from the plurality of servers corresponding to the server class. The system, method, and computer readable medium forward the request to one of the one or more servers based on the estimate response times.

### TECHNICAL FIELD

Aspects of the present disclosure relate to load balancing data requests, and more particularly, to using a neural network-based load balancer to process requests in a distributed storage system.

### BACKGROUND

A distributed storage system is an infrastructure that splits data across multiple physical servers, and often across more than one data center. A distributed storage system typically takes the form of a cluster of storage units, with a mechanism for data synchronization and coordination between cluster nodes.

Load balancing is the process of distributing a set of tasks (e.g., data requests) over a set of resources (computing units). The purpose of a load balancer is to balance the set of tasks across the set of resources to optimize response times and avoid unevenly overloading some compute nodes.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram that illustrates an example system of using a machine learning model to dynamically select a resource from a distributed storage system for processing a request, in accordance with some embodiments of the present disclosure.

FIG. 3 is a block diagram that illustrates an example system for processing requests in a distributed storage system using a neural network-based machine learning model for load balancing, in accordance with some embodiments of the present disclosure.

FIG. 4A illustrates an example of server parameters that are utilized to train a machine learning model, in accordance with some embodiments of the present disclosure.

FIG. 4B illustrates an example of different server classifications, in accordance with some embodiments of the present disclosure.

FIG. 4C illustrates an example of estimate response times computed by the different executor layers for their corresponding servers, in accordance with some embodiments of the present disclosure.

FIG. 5 is a flow diagram of a method of using a neural network-based machine learning model for load balancing a distributed storage system, in accordance with some embodiments of the present disclosure.

FIG. 6 is a block diagram of an example computing device that may perform one or more of the operations described herein, in accordance with some embodiments of the present disclosure.

### DETAILED DESCRIPTION

Conventional load balancing systems may be categorized into static load balancing systems, dynamic load balancing systems, and adaptive load balancing systems. In static load balancing systems, tasks are performed using deterministic or probabilistic algorithms based on a static condition. As such, static load balancing systems do not account for the current state of the distributed storage system. For example, a Round Robin approach assigns incoming requests to successive servers (server 1, server 2, server 3, server 1, server 2, etc.) based on a predefined rule set and does not consider the current state of the servers, such as whether one of the servers is overloaded from processing a number of complex tasks, while another one of the servers is idle after processing simple tasks. In turn, static load balancing systems have difficulty in real-time resource load balancing.

In dynamic load balancing systems, an algorithm is selected to make decisions according to the current state of the system. The objective of the dynamic load balancing algorithm is to improve system performance, and the algorithm adopts a performance index based on which performance improvement is measured, such as a system performance-oriented index, a user-oriented index, or both. Since there is more than one index (algorithm) that can be utilized, but only one algorithm is allowable, selecting the incorrect algorithm can be detrimental to system performance.

Adaptive load balancing systems are the most complex where the operating strategy changes with environmental changes. Many adaptive load balancing systems use a neuro-fuzzy approach to estimate the response time such as Ant Colony Optimization (ACO), Artificial Bee colony (ABC) optimization, etc. These approaches require substantial time in the learning process because of complex activation functions and processes being used that, in turn, increase the request response time in operation.

The present disclosure addresses the above-noted and other deficiencies by a method of load distribution using a neural network-based machine learning model that dynamically selects a resource from a distributed storage system to process a request having a minimal response time. In some embodiments, a processing device trains a machine learning model using server parameters corresponding to a plurality of servers in the distributed storage system, wherein the training produces an optimized feature set of the machine learning model. The processing device, responsive to receiving a request, assigns a server class to the request based on the optimized feature set. The processing device computes, based on the optimized feature set, estimate response times for one or more of the servers that correspond to the server class. The processing device then forwards the request to one of the one or more servers based on the estimate response times.

In some embodiments, the processing device captures performance parameters of the server that was forwarded the request while the server is processing the request. The processing device then retrains the machine learning model using the performance parameters.

In some embodiments, the processing device computes servicing requests times of each of the one or more servers. The processing device then prioritizes the request based on the servicing requests times.

In some embodiments, the processing device computes one or more current server loads for each of the one or more servers. The processing device identifies a number of static requests currently being processed by each of the one or more servers, and identifies a number of dynamic requests currently being processed by each of the one or more servers. The processing device then computes the estimate response times for the one or servers based on their corresponding server load, number of static requests currently being processed, and number of dynamic requests currently being processed.

In some embodiments, the processing device determines whether the request is a static request type or a dynamic request type, and then assigns the server class to the request based on the request type.

In some embodiments, the processing device analyzes computing resources dedicated to each of the plurality of servers. The processing device then assigns a server class to each of the plurality of servers based on their corresponding computing resources.

In some embodiments, the machine learning model comprises a classifier layer, a calculator layer, a decision layer, a forwarder layer, and a plurality of executor layers, wherein each of the plurality of executor layers is assigned to one of the plurality of servers.

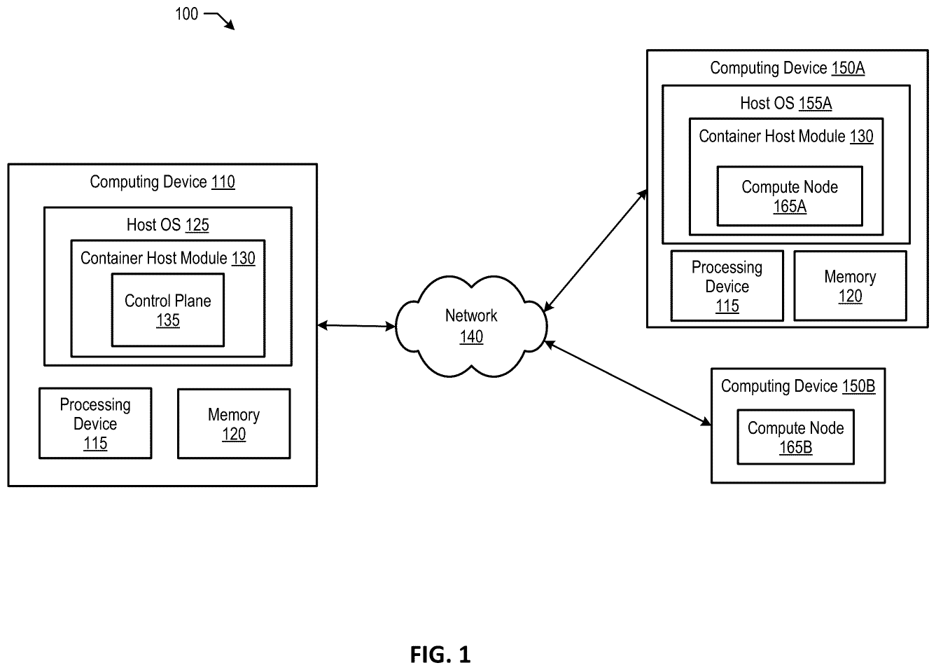

FIG. 1 is a block diagram that illustrates an example system 100. As illustrated in FIG. 1, system 100 includes a computing device 110, and a plurality of computing devices 150. The computing devices 110 and 150 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In some embodiments, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g. cell towers), etc. In some embodiments, the network 140 may be an L3 network. The network 140 may carry communications (e.g., data, message, packets, frames, etc.) between computing device 110 and computing devices 150. Each one of computing devices 110 and 150 may include hardware such as processing device 115 (e.g., processors, central processing units (CPUs)), memory 120 (e.g., random access memory 120 (e.g., RAM)), storage devices (e.g., hard-disk drive (HDD), solid-state drive (SSD), etc.), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 150 may comprise a single machine or may include multiple interconnected machines (e.g., multiple servers configured in a cluster). The computing devices 110 and 150 may be implemented by a common entity/organization or may be implemented by different entities/organizations. For example, computing device 110 may be operated by a first company/corporation and one or more computing devices 150 may be operated by a second company/corporation. Each of computing device 110 and computing devices 150 may execute or include an operating system (OS) such as host OS 125 and host OS 155 respectively, as discussed in more detail below. The host OS of computing devices 110 and 150 may manage the execution of other components (e.g., software, applications, etc.) and/or may manage access to the hardware (e.g., processors, memory, storage devices etc.) of the computing device. In some embodiments, computing device 110 may implement a control plane (e.g., as part of a container orchestration engine) while computing devices 150 may each implement a compute node (e.g., as part of the container orchestration engine).

In some embodiments, a container orchestration engine 130 (referred to herein as container host 130), such as the Redhat™ OpenShift™ module, may execute on the host OS 125 of computing device 110 and the host OS 155 of computing device 150, as discussed in further detail herein. The container host module 130 may be a platform for developing and running containerized applications and may allow applications and the data centers that support them to expand from just a few machines and applications to thousands of machines that serve millions of clients. Container host 130 may provide an image-based deployment module for creating containers and may store one or more image files for creating container instances. Many application instances can be running in containers on a single host without visibility into each other's processes, files, network, and so on. Each container may provide a single function (often called a “micro-service”) or component of an application, such as a web server or a database, though containers can be used for arbitrary workloads. In this way, the container host 130 provides a function-based architecture of smaller, decoupled units that work together.

Container host 130 may include a storage driver (not shown), such as OverlayFS, to manage the contents of an image file including the read only and writable layers of the image file. The storage driver may be a type of union file system which allows a developer to overlay one file system on top of another. Changes may be recorded in the upper file system, while the lower file system (base image) remains unmodified. In this way, multiple containers may share a file-system image where the base image is read-only media.

An image file may be stored by the container host 130 or a registry server. In some embodiments, the image file may include one or more base layers. An image file may be shared by multiple containers. When the container host 130 creates a new container, it may add a new writable (e.g., in-memory) layer on top of the underlying base layers. However, the underlying image file remains unchanged. Base layers may define the runtime environment as well as the packages and utilities necessary for a containerized application to run. Thus, the base layers of an image file may each comprise static snapshots of the container's configuration and may be read-only layers that are never modified. Any changes (e.g., data to be written by the application running on the container) may be implemented in subsequent (upper) layers such as in-memory layer. Changes made in the in-memory layer may be saved by creating a new layered image.

While the container image is the basic unit containers may be deployed from, the basic units that the container host 130 may work with are called pods. A pod may refer to one or more containers deployed together on a single host, and the smallest compute unit that can be defined, deployed, and managed. Each pod is allocated its own internal IP address, and therefore may own its entire port space. Containers within pods may share their local storage and networking. In some embodiments, pods have a lifecycle in which they are defined, they are assigned to run on a node, and they run until their container(s) exit or they are removed based on their policy and exit code. Although a pod may contain more than one container, the pod is the single unit that a user may deploy, scale, and manage. The control plane 135 of the container host 130 may include replication controllers (not shown) that indicate how many pod replicas are required to run at a time and may be used to automatically scale an application to adapt to its current demand.

By their nature, containerized applications are separated from the operating systems where they run and, by extension, their users. The control plane 135 may expose applications to internal and external networks by defining network policies that control communication with containerized applications (e.g., incoming HTTP or HTTPS requests for services inside the cluster 165).

A typical deployment of the container host 130 may include a control plane 135 and a cluster of compute nodes 165, including compute nodes 165A and 165B (also referred to as compute machines). The control plane 135 may include REST APIs which expose objects as well as controllers which read those APIs, apply changes to objects, and report status or write back to objects. The control plane 135 manages workloads on the compute nodes 165 and also executes services that are required to control the compute nodes 165. For example, the control plane 135 may run an API server that validates and configures the data for pods, services, and replication controllers as well as provides a focal point for the cluster 165's shared state. The control plane 135 may also manage the logical aspects of networking and virtual networks. The control plane 135 may further provide a clustered key-value store (not shown) that stores the cluster 165's shared state. The control plane 135 may also monitor the clustered key-value store for changes to objects such as replication, namespace, and service account controller objects, and then enforce the specified state.

The cluster of compute nodes 165 are where the actual workloads requested by users run and are managed. The compute nodes 165 advertise their capacity and a scheduler (not shown), which is part of the control plane 135, determines which compute nodes 165 containers and pods will be started on. Each compute node 165 includes functionality to accept and fulfill requests for running and stopping container workloads, and a service proxy, which manages communication for pods across compute nodes 165. A compute node 165 may be implemented as a virtual server, logical container, or GPU, for example.

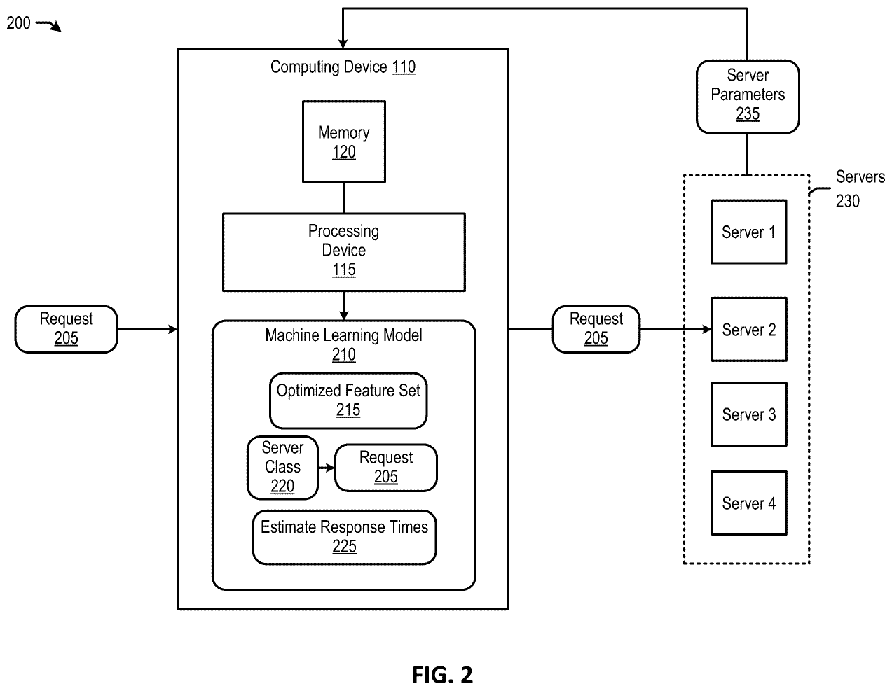

FIG. 2 is a block diagram that illustrates an example system of using a machine learning model to dynamically select a resource from a distributed storage system for processing a request, in accordance with some embodiments of the present disclosure.

System 200 includes computing device 110, which includes processing device 115 coupled to memory 120. Processing device 115 trains machine learning model 210 using server parameters 235 that correspond to servers 230 (server 1, 2, 3, 4). The training process produces an optimized feature set 215 of the machine learning model 210.

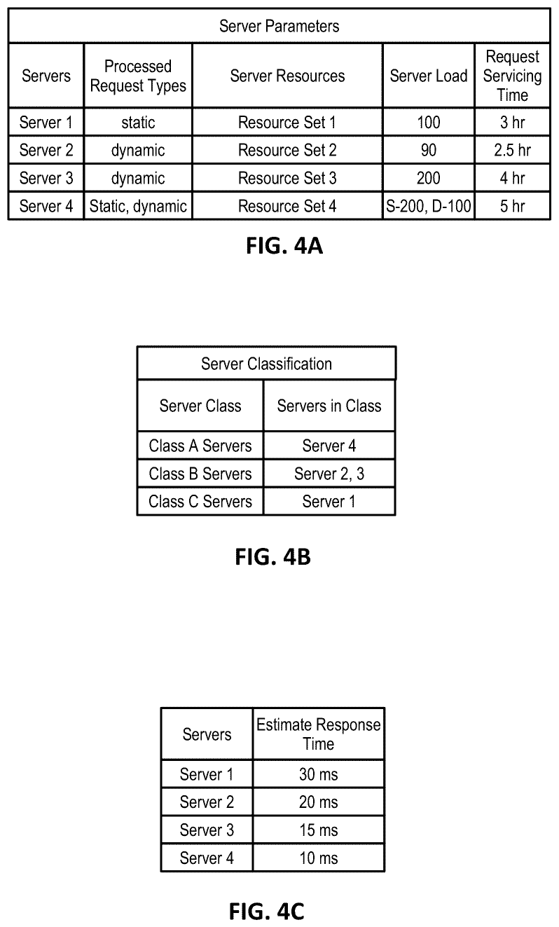

Processing device 115 then receives request 205 and uses machine learning model 210 with optimized feature set 215 to assigns a server class 220 to the request 205. Referring to the example shown in FIG. 4B, the server class may be class “A,” “B,” “C,”, etc. based on properties of request 205 (e.g., static request, dynamic request, etc.)

Using the optimized feature set 215, processing device 115 computes estimate response times 225 for one or more of the servers 230 corresponding to the server class 220. For example, if the server class assigned to request 205 is class “B,” then the example in FIG. 4B shows that the servers in class B are server 2 and server 3. Processing device 115 then selects one of the servers corresponding to the server class based on the estimate response times 225 and forwards the request 205 to the selected server in servers 230. The example shown in FIG. 2 shows that request 205 is forwarded to server 2 for processing.

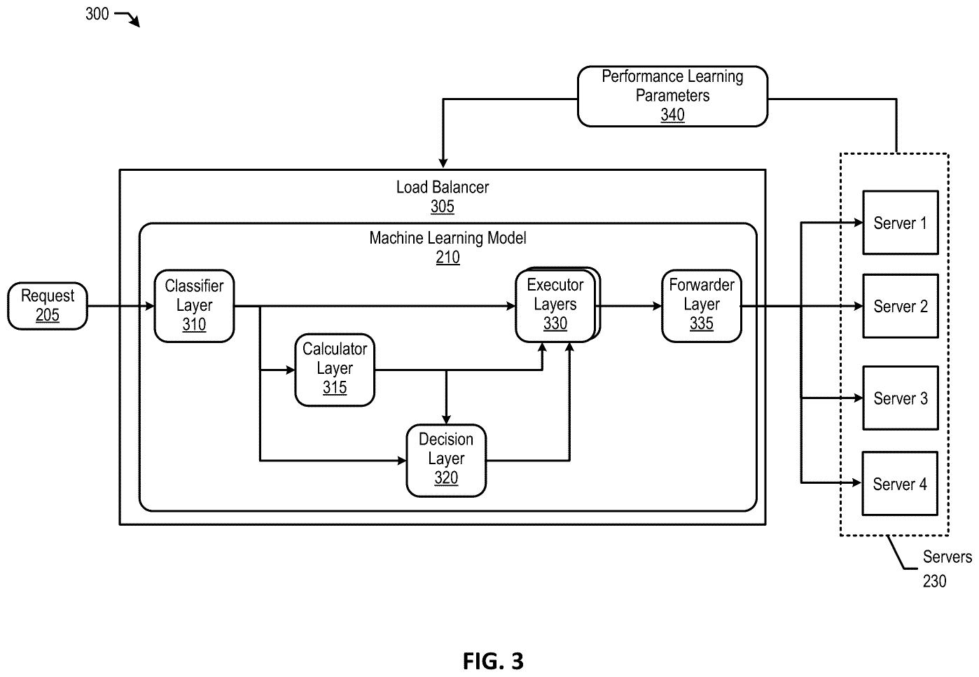

FIG. 3 is a block diagram that illustrates an example system for processing requests in a distributed storage system using a neural network-based machine learning model for load balancing, in accordance with some embodiments of the present disclosure. System 300 includes load balancer 305 that distributes requests 205 to servers 230 based on resource selection decisions from machine learning model 210. Machine learning model 210 includes classifier layer 310, calculator layer 315, decision layer 320, executor layers 330, and forwarder layer 335. In some embodiments, machine learning model 210 is trained using supervised learning and/or unsupervised learning, and may be based, for example, on server parameters shown in FIG. 4A. During the training process, machine learning model 210 receives the following input features from a corpus and optimizes to a target variable that identifies a server that serves incoming requests with minimal response time:
si: a number of static tasks currently serviced on a server;
di: a number of dynamic tasks currently serviced on a server;
ci: class type of request;
pi: current request type (static request type or dynamic request type); and
tri−1: value of the last predicted request response time.

Once machine learning model 210 is trained, load balancer 305 receives request 205 and classifier layer 310 assigns a request type (pi) (e.g., static request type or dynamic request type) based on request 205's characteristics, such as a request for a script to be executed on a server (e.g., PHP, Python, Java) or a request to download a static file (e.g., an image file). Classifier layer 310 then assigns a class (ci) to request 205 based on, for example, the request type, the size of requested file, current load of servers 230, current requests count, etc. In some embodiments load balancer 305 uses a separate neural network for class segmentation.

Calculator layer 315 calculates the time of servicing request 205 and its estimate load on servers 230, and passes the information to executor layers 330 and decision layer 320. Decision layer 320 prioritizes request 205 using the information from classifier layer 310 and calculator layer 315. For example, decision layer 320 may prioritize one request over another request based on a client's service level agreement (SLA). Decision layer 320 then passes the prioritization information to executor layers 330.

Each executor layer in executor layers 330 is associated with one of servers 230. Each one of the executor layers 330 estimate the response time to process request 205 of their associated servers 230, taking into account request 205 estimate load, and number of static requests (si) and dynamic requests (di) currently being processed. Forwarder layer 335 receives estimate response times from each one of executor layers 330. In turn, forwarder layer 335 forwards the request 205 to the server 230 having the shortest estimate response time.

In some embodiments, system 300 utilizes reinforcement learning by capturing performance learning parameters 340 and retrains machine learning model 210 using performance learning parameters 340. In some embodiments, performance learning parameters 340 are performance parameters of the server that is currently processing request 205.

FIG. 4A illustrates an example of server parameters that are utilized to train machine learning model 210, in accordance with some embodiments of the present disclosure. FIG. 4A shows server parameter data for four servers and includes, for each server, the type of request they will process (static, dynamic, both) based on their corresponding server resources (#CPUs, memory, bandwidth connection, etc.). For example, servers 1-4 may have the following resources:
Server 1: 2 CPU's, 2 GB RAM, Storage media—HDD, 100 MB network capacity;
Server 2: 4 CPU's, 32 GB RAM, Storage media—SSD, 100 MB network capacity;
Server 3: 4 CPU's, 32 GB RAM, Storage media—SSD, 100 MB network capacity; and
Server 4: 8 CPU's, 64 GB RAM, Storage media—SSD, 1000 MB network capacity.

In the example above, server 1 has the least amount of server resources, servers 2 and 3 have a mid-level amount of server resources, and server 4 has the most amount of server resources. As such, and referring to FIG. 4A, server 1 supports static requests, servers 2 and 3 support dynamic requests, and server 4 supports both static requests and dynamic requests. FIG. 4A also shows server load capacities and expected time to service requests, which are also typically based on the server resources.

FIG. 4B illustrates an example of different server classifications, in accordance with some embodiments of the present disclosure. In some embodiments, a server is assigned a server class based on its corresponding resources and sever performance discussed above. As can be seen, server 4 is a class A server (highest class), servers 2 and 3 are class B servers (middle class), and server 4 is a class C server (lowest class). As such, the server classification that classifier layer 310 assigns to request 205 will determine which of the executor layers 330 will evaluate the request. For example, if classifier layer 310 assigns a class “B” server classification to request 205, then only the executor layers 330 associated with servers 2 and 3 will perform computations to determine estimate response times. In some embodiments, executor layers other than those that meet the server classification, but can support request 205, may also compute estimate response times. For example, if request 205 is assigned a class “C” classification, which is the lowest classification, each one of the servers 1-4 are capable of processing request 205 and their corresponding executor layers may compute estimate response times.

FIG. 4C illustrates an example of estimate response times computed by the different executor layers 330 for their corresponding servers 230, in accordance with some embodiments of the present disclosure. When executor layers 330 receive information from classifier layer 310, calculator layer 315, and decision layer 320, executor layers 330 (or a portion of executor layers 330) compute estimate response to process request 205 similar to those shown in FIG. 4C. Each of the executor layers 330 sends their corresponding estimate response times to forwarder layer 335. In turn, forwarder layer 335 selects the server corresponding to the least response time (e.g., server 4 at 10 ms) and forwards request 205 to the selected server.

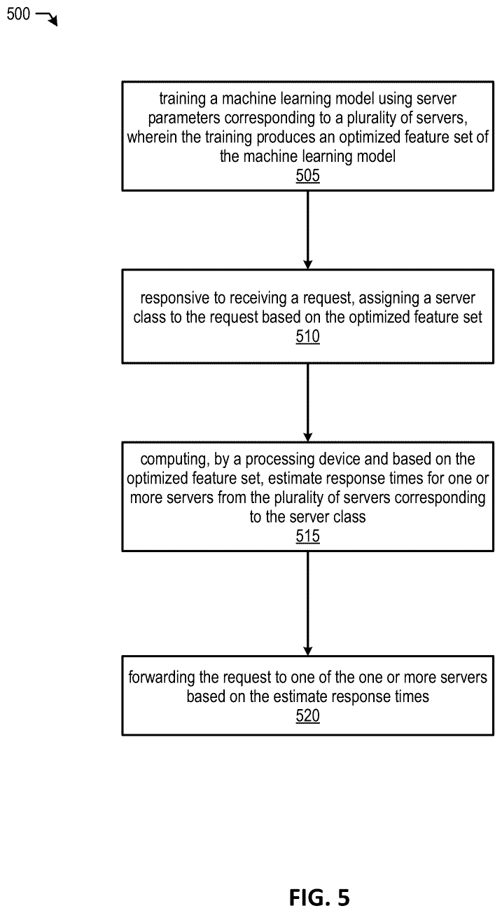

FIG. 5 is a flow diagram of a method of using a neural network-based machine learning model for load balancing a distributed storage system, in accordance with some embodiments of the present disclosure. Method 500 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by processing device 115 shown in FIG. 1.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 505, where processing logic trains a machine learning model using server parameters corresponding to a plurality of servers. The training produces an optimized feature set of the machine learning model. At block 510, responsive to receiving a request, processing logic assigns a server class to the request based on the optimized feature set, such as class “A,” class “B,” or class “C.”. At block 515, processing logic computes, based on the optimized feature set, estimate response times for one or more servers from the plurality of servers corresponding to the server class. At block 520, processing logic forwards the request to one of the one or more servers based on the estimate response times.

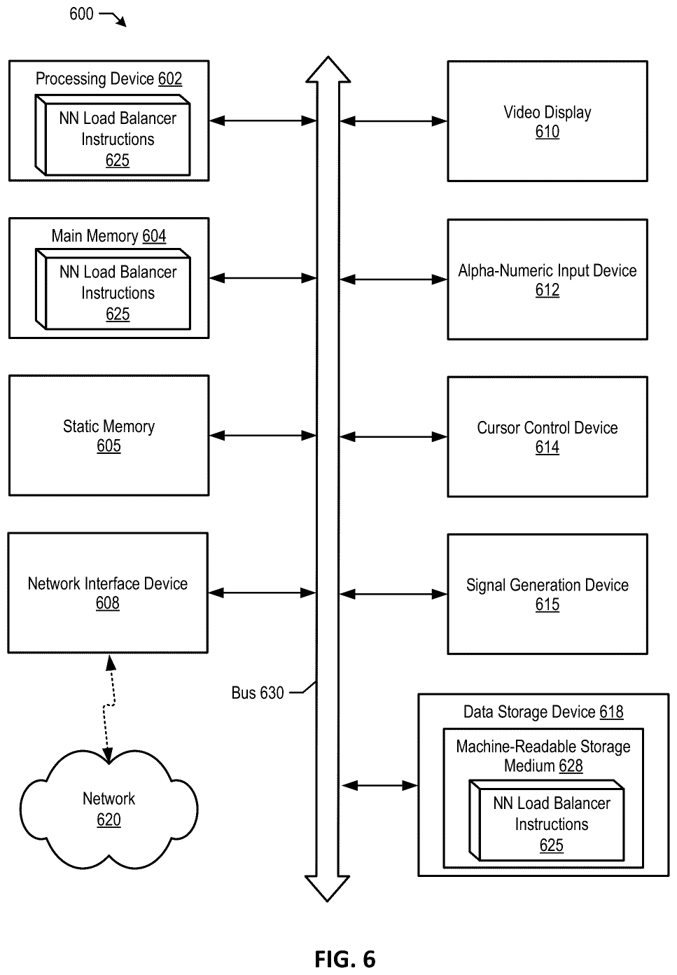

FIG. 6 illustrates a diagrammatic representation of a machine in the example form of a computer system 600 within which a set of instructions, for causing the machine to perform any one or more of the methodologies discussed herein for intelligently scheduling containers.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute neural network (NN) load balancer instructions 625, for performing the operations and steps discussed herein.

The data storage device 618 may include a machine-readable storage medium 628, on which is stored one or more sets of NN load balancer instructions 625 (e.g., software) embodying any one or more of the methodologies of functions described herein. The NN load balancer instructions 625 may also reside, completely or at least partially, within the main memory 604 or within the processing device 602 during execution thereof by the computer system 600; the main memory 604 and the processing device 602 also constituting machine-readable storage media. The NN load balancer instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
training a machine learning model using server parameters corresponding to a plurality of servers, wherein the training produces an optimized feature set of the machine learning model;
responsive to receiving a request, assigning a server class to the request based on the optimized feature set;
computing, by a processing device and based on the optimized feature set, estimate response times for one or more servers from the plurality of servers corresponding to the server class; and
forwarding the request to one of the one or more servers based on the estimate response times.

2. The method of claim 1, further comprising:
capturing performance parameters of the server that was forwarded the request while the server is processing the request; and
retraining the machine learning model using the performance parameters.

3. The method of claim 1, further comprising:
computing servicing requests times of each of the one or more servers; and
prioritizing the request based on the servicing requests times.

4. The method of claim 1, further comprising:
computing one or more current server loads for each of the one or more servers;
identifying a number of static requests currently being processed by each one of the one or more servers;
identifying a number of dynamic requests currently being processed by each one of the one or more servers; and
computing the estimate response times for the one or servers based on their corresponding server load, the number of static requests currently being processed, and the number of dynamic requests currently being processed.

5. The method of claim 1, further comprising:
determining a request type of the request, wherein the request type is selected from the group consisting of a static request type and a dynamic request type; and
assigning the server class to the request based on the request type.

6. The method of claim 1, further comprising:
analyzing computing resources dedicated to each of the plurality of servers; and
assigning a server class to each of the plurality of servers based on their corresponding computing resources.

7. The method of claim 1, wherein the machine learning model comprises a classifier layer, a calculator layer, a decision layer, a forwarder layer, and a plurality of executor layers, wherein each one of the plurality of executor layers is assigned to one of the plurality of servers.

8. A system comprising:
a memory; and
a processing device operatively coupled to the memory, the processing device to:
train a machine learning model using server parameters corresponding to a plurality of servers, wherein the training produces an optimized feature set of the machine learning model;
responsive to receiving a request, assign a server class to the request based on the optimized feature set;
compute, based on the optimized feature set, estimate response times for one or more servers from the plurality of servers corresponding to the server class; and
forward the request to one of the one or more servers based on the estimate response times.

9. The system of claim 8, wherein the processing device is to:
capture performance parameters of the server that was forwarded the request while the server is processing the request; and
retrain the machine learning model using the performance parameters.

10. The system of claim 8, wherein the processing device is to:
compute servicing requests times of each of the one or more servers; and
prioritize the request based on the servicing requests times.

11. The system of claim 8, wherein the processing device is to:
compute one or more current server loads for each of the one or more servers;
identify a number of static requests currently being processed by each one of the one or more servers;
identify a number of dynamic requests currently being processed by each one of the one or more servers; and
compute the estimate response times for the one or servers based on their corresponding server load, the number of static requests currently being processed, and the number of dynamic requests currently being processed.

12. The system of claim 8, wherein the processing device is to:
determine a request type of the request, wherein the request type is selected from the group consisting of a static request type and a dynamic request type; and
assign the server class to the request based on the request type.

13. The system of claim 8, wherein the processing device is to:
analyze computing resources dedicated to each of the plurality of servers; and
assign a server class to each of the plurality of servers based on their corresponding computing resources.

14. The system of claim 8, wherein the machine learning model comprises a classifier layer, a calculator layer, a decision layer, a forwarder layer, and a plurality of executor layers, wherein each one of the plurality of executor layers is assigned to one of the plurality of servers.

15. A non-transitory computer readable medium, having instructions stored thereon which, when executed by a processing device, cause the processing device to:
train a machine learning model using server parameters corresponding to a plurality of servers, wherein the training produces an optimized feature set of the machine learning model;
responsive to receiving a request, assign a server class to the request based on the optimized feature set;
compute, by the processing device and based on the optimized feature set, estimate response times for one or more servers from the plurality of servers corresponding to the server class; and
forward the request to one of the one or more servers based on the estimate response times.

16. The non-transitory computer readable medium of claim 15, wherein the processing device is to:
capture performance parameters of the server that was forwarded the request while the server is processing the request; and
retrain the machine learning model using the performance parameters.

17. The non-transitory computer readable medium of claim 15, wherein the processing device is to:
compute servicing requests times of each of the one or more servers; and
prioritize the request based on the servicing requests times.

18. The non-transitory computer readable medium of claim 15, wherein the processing device is to:
compute one or more current server loads for each of the one or more servers;
identify a number of static requests currently being processed by each one of the one or more servers;
identify a number of dynamic requests currently being processed by each one of the one or more servers; and
compute the estimate response times for the one or servers based on their corresponding server load, the number of static requests currently being processed, and the number of dynamic requests currently being processed.

19. The non-transitory computer readable medium of claim 15, wherein the processing device is to:
determine a request type of the request, wherein the request type is selected from the group consisting of a static request type and a dynamic request type; and
assign the server class to the request based on the request type.

20. The non-transitory computer readable medium of claim 15, wherein the processing device is to:
analyze computing resources dedicated to each of the plurality of servers; and
assign a server class to each of the plurality of servers based on their corresponding computing resources.
